(19) United States
(12) Patent Application Publication
(10) Pub. No.: US 2011/0005489 A1
(43) Pub. Date: Jan. 13, 2011

(54) Advanced angled-cylinder piston device

(76) Inventor: Ronald Lewis, East Yaphank, NY (US)

Correspondence Address: Ronald Lewis, 466 Helene Avenue, East Yaphank, NY, 11967, US

(21) Appl. No.: 12/802,317

(22) Filed: Jun. 5, 2010

Related U.S. Application Data
(60) Provisional application No. 61/217,858, filed on Jun. 6, 2009.
(60) Provisional application No. 61/271,522, filed on Jul. 22, 2009.
(60) Provisional application No. 61/271,523, filed on Jul. 22, 2009.
(60) Provisional application No. 61/273,363, filed on Aug. 3, 2009.
(60) Provisional application No. 61/340,083, filed on Mar. 12, 2010.

(51) Int. Cl. F02F 3/00

(52) U.S. Cl. 123/193.1

(57) ABSTRACT

An advanced angled cylinder piston engine, pump, or compressor design. A method to determine optimum cylinder(s) orientation to achieve maximum torque. A method to determine proper cylinder(s) orientation achievable based on crankshaft and connecting rod dimensions. A cylinder, a cylinder insert sleeve, and a piston provide clearance for free operation of a connecting rod. A compensating piston provides proper cylinder volume to maintain desired compression ratio. An oil passage provides additional lubrication to cylinder wall. A crankshaft counterweight orientation provides proper crankshaft, connecting rod, and piston assembly balance.

### CROSS-REFERENCE TO RELATED APPLICATIONS

This application claims the benefit of provisional patent applications filed by the present inventor:

Application No. 61/217,858, filed 2009 Jun. 6, Confirmation No. 5343
Application No. 61/271,522, filed 2009 Jul. 22, Confirmation No. 3572
Application No. 61/271,523, filed 2009 Jul. 22, Confirmation No. 3755
Application No. 61/273,363, filed 2009 Aug. 3, Confirmation No. 7705
Application No. 61/340,083, filed 2010 Mar. 12, Confirmation No. 3185

### BACKGROUND

### Prior Art

The following is a tabulation of some prior art that presently appears relevant:

U.S. Patents

| Patent Number | Issue Date | Patentee |
|---|---|---|
| 6,058,901 | 2000 May 9 | Lee |
| 6,745,746 B1 | 2004 Jun. 8 | Ishii |
| 4,664,077 | 1987 May 12 | Kamimaru |
| 5,816,201 | 1998 Oct. 06 | Garvin |
| 6,827,057 | 2004 Dec. 07 | Dawson |
| 5,076,220 | 1991 Dec. 31 | Evans, et al |
| 6,612,281 B1 | 2003 Oct. 2 | Martin |
| 4,708,096 | 1987 Nov. 24 | Mroz |
| 5,186,127 | 1993 Feb. 16 | Custico |
| 5,544,627 | 1996 Aug. 13 | Terdev, et al. |
| 4,702,151 | 1987 Oct. 27 | Munro, et al. |
| 7,543,556 B2 | 2009 Jun. 9 | Hees, et al. |

### NONPATENT LITERATURE DOCUMENTS

Dr. Taj Elssir Hassan, “Theoretical Performance Comparison between Inline, Offset and Twin Crankshaft Internal Combustion Engines” (July 2008)
www.speedtalk.com/forum/Offset Bore & Crank Centerlines

The angled-cylinder or offset-crankshaft technique of designing internal and external combustion piston engines, piston pumps, and gas compressors is a technology that has been met with limited success. Designers of such devices have little guidance when employing this design technique to achieve results that produce a piston device that yields maximum performance gains, while requiring a minimum amount of modifications to traditional or existing engine, pump, or compressor designs.

Previous efforts to test and document the performance gains offered by the angled-cylinder or offset-crankshaft technology have employed tests that were conducted on internal combustion engines. Prototypes were constructed, and cylinder pressures, thermo-dynamics, and other characteristics of these engines were taken while in operation—for example discussion www.eng-tips.com/forum/thread7-201777, www.speedtalk.com/forum/offset bore & crank centerlines and U.S. Pat. No. 6,058,901 to Lee (2000). These tests mainly focused on some specific offset-crankshaft configuration targeted at some specific point in the combustion stroke. Additionally, new prototypes needed to be constructed to test configuration variables. This limited method of testing has produced misleading results.

Another method used to compare the performance between angled-cylinder or offset-crankshaft piston devices with conventionally configured piston devices focused on piston-to-sidewall frictions—for example “Reration between Crankshaft Offset and Piston Friction Loss. Amount of Offset and Engine Operating Condition”—Takiguchi Masaaki. Other efforts that have been employed are computer simulations and mathematical studies—for example www.camotruck.net/rollins/piston-offset, Theoretical Performance Comparison between Inline, Offset, and Twin Crankshaft Internal Combustion Engines—Taj Elssir Hasaan. These methods of determining performance gains have also produced misleading results.

The orientation of the cylinder in such devices is extremely critical to performance. Some of the prior art related to the angled-cylinder or offset-crankshaft suggest values that are ineffective—for example U.S. Pat. No. 6,745,746 B1 to Ishii (2004) and U.S. Pat. No. 4,664,077 to Kamimaru (1987). Others specify designs that are too impractical to be viable—for example U.S. Pat. No. 5,816,201 to Garvin (1998) and U.S. Pat. No. 6,827,057 to Dawson (2004). Still other prior art and patents are very indeterminate in defining this relationship. Such terms as “approximately” and “about” are typically used—for example U.S. Pat. No. 6,612,281 B1 to Martin (2003) and U.S. Pat. No. 5,076,220 to Evans et al (1991). Additionally, if values are expressed in prior art at all, they fail to take into consideration other critical factors such as connecting rod-to-stroke ratios, which would render any expressed value effectively meaningless—for example U.S. Pat. No. 4,708,096 to Mroz (1987).

Designers of piston devices wishing to employ the angled-cylinder or offset-crankshaft technology have also been confronted with mechanical interferences and clearance limitations between the cylinder, connecting rod, and piston. Prior art that has addressed this issue specify connecting rod designs that alter the connecting rod centerline, and therefore would be prone to early failure—for example U.S. Pat. No. 5,186,127 to Cuatico (1993) and US patent to Terzlev (1996). Manufacturers of piston devices would be reluctant to adopt such designs. Other prior art addressing this problem suggest integrating modifications to the block casting—for example U.S. Pat. No. 4,708,096 to Mroz. (1987). As the close proximity of the piston components with the bottom of the cylinder are critical in these devices, this approach would prove challenging in the manufacturing process.

Other concerns encountered when designing a piston device employing the angled-cylinder or offset-crankshaft technology have no known directly related prior art.

### ADVANTAGES

Accordingly designs and methods for providing designers of angled-cylinder piston devices with the ability to produce a device that benefits from the mechanical advantage inherent in the technology, while requiring as few modifications to existing or traditional designs as possible, thus making the angled-cylinder or offset-crankshaft technology viable.

### DETAILED DESCRIPTION

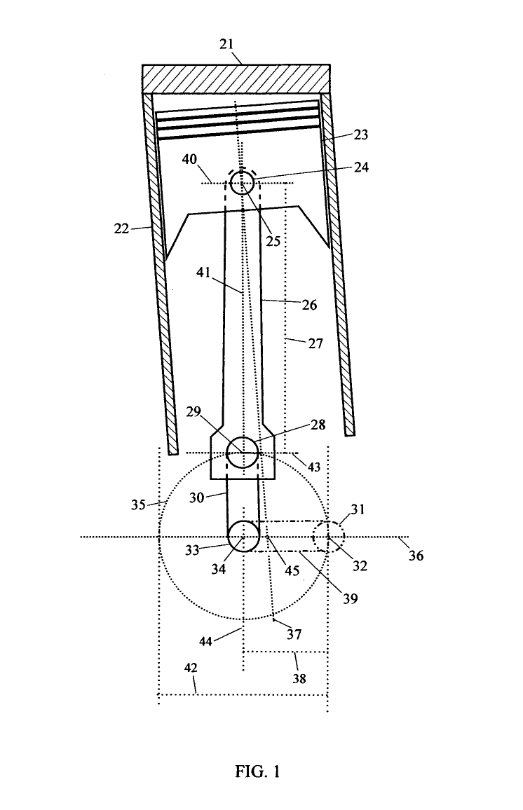

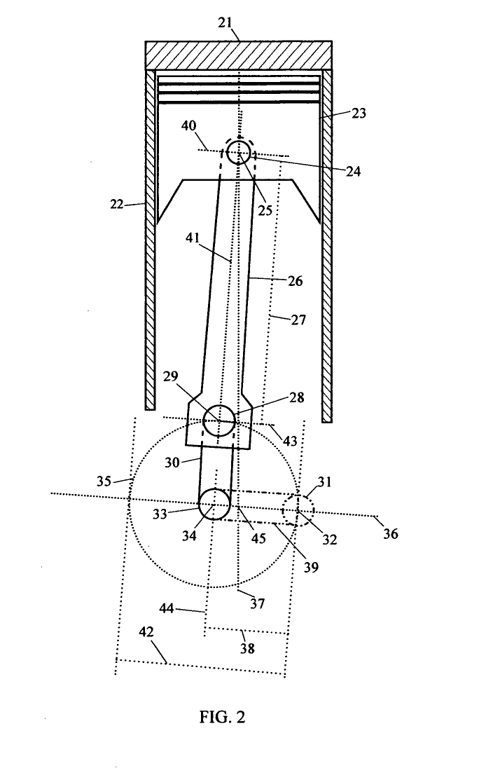

### FIGS. 1 and 2—First Embodiment

FIGS. 1 and 2 share all the same components. A cylinder head 21 could contain valves, spark plugs or other components that are not necessary for this disclosure, and therefore are not included. The cylinder 22 can be a bore in a block casting, a sleeve inserted into a bore, or an independent structure. A piston 23 and a connecting rod 26 are pivotally joined at a piston pivot 24. A piston pivot center axis 25, and a piston pivot horizontal centerline 40 are included for reference purposes. A crankshaft main journal 33, a throw 30, and a crankpin 28 represent the moving components of a crankshaft, or crankshaft assembly, and positioned at top-dead-center (TDC). A crankshaft main axis of rotation 34, and a crankpin center axis 32 are included for reference purposes. A stroke reference line 35 is included to show the travel of the crankpin center axis 29 as the crankshaft rotates 360° through an operating cycle. A length of connecting rod 27 and a length of throw 38 are included, as these dimensions are necessary for this disclosure. Both FIGS. 1 and 2 are drawings of what could be a single cylinder device, or one cylinder of a multiple cylinder device.

FIG. 1 is a drawing of an example of a piston device designed using the angled-cylinder technique. A piston engine employing this design technique basically begins with a traditional or existing design, and with the crankshaft 28,30,33 positioned to place the piston 23 at TDC (shown), a cylinder's centerline 37 orientation is rotated about the piston pivot center axis 25 location, thus orienting the cylinder's base in the direction of the crankpin 28 as the crankshaft's 28,30,33 operational rotation moves the crankpin 28 from TDC to bottom-dead-center (BDC). In the case of a compressor or pump, the cylinder's centerline 37 orientation is rotated about the piston pivot center axis 25 location to orient the cylinder's 22 base in the direction of the crankpin 28 as the crankshaft's 28,30,33 operational rotation moves from BDC to TDC.

FIG. 2 is an example of a piston device designed using the offset-crankshaft or offset-cylinder technique. A piston engine employing this design technique also begins with a traditional or an existing design, and the crankshaft's main axis of rotation 34 is offset in a perpendicular direction away from the cylinder's centerline 37, toward the direction of the crankpin 28 as the crankshaft's 28,30,33 operational rotation moves the crankpin 28 from BDC to TDC. In the case of a compressor or pump, the crankshaft's main axis of rotation 34 is offset in a perpendicular direction from the cylinder's centerline 37, and toward the crankpin 28 as the crankshaft's 28,30,33 operational rotation moves the crankpin 28 from TDC to BDC.

If corrected for TDC, the angled-cylinder and the-offset crankshaft design techniques both produce a piston device with identical piston 21, cylinder 22, connecting rod 26, and throw 39 component relationships. The difference between these two design techniques involves which components of a traditional or existing design will be altered to achieve the desired result. Therefore, going forward, this design technique will be referred to as the angled-cylinder design, as when considering only the basic components involved, it is a more generic description.

As previously disclosed, the angled-cylinder technique can be applied to engines, gas compressors and liquid pumps. In the case of an engine, either internal combustion such as a gasoline or diesel engine, or external combustion such as a steam engine, the direction of rotation of the crankshaft 28,30,33 in FIGS. 1 and 2 would be clockwise. In the case of a gas compressor or liquid pump, the direction of rotation of the crankshaft 28,30,33 would be counter-clockwise. The throw 30, and the crankpin 28 are represented in an alternate position of the operating cycle, 39 and 31. In the case of an engine, this position would be 90° past TDC of a 360° clockwise crankshaft 28,30,33 rotation. In the case of a gas compressor or liquid pump, this position would be 270° past TDC of a 360° counter-clockwise crankshaft 28,30,33 rotation.

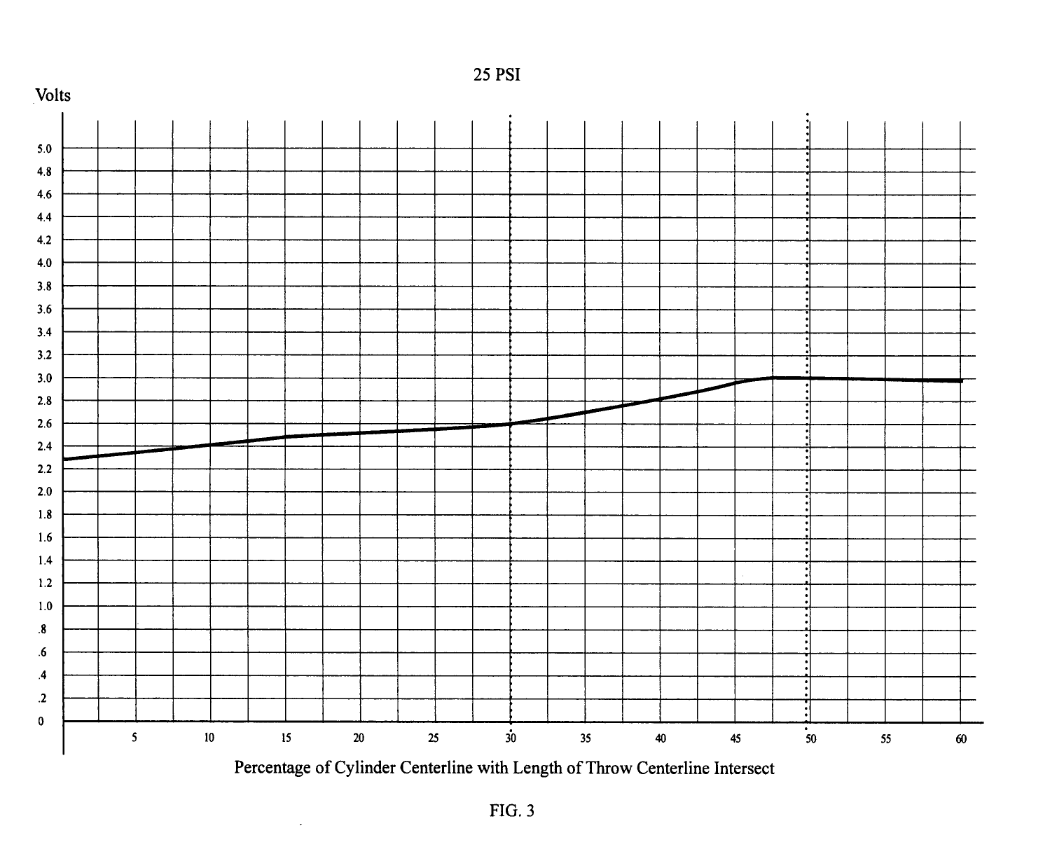

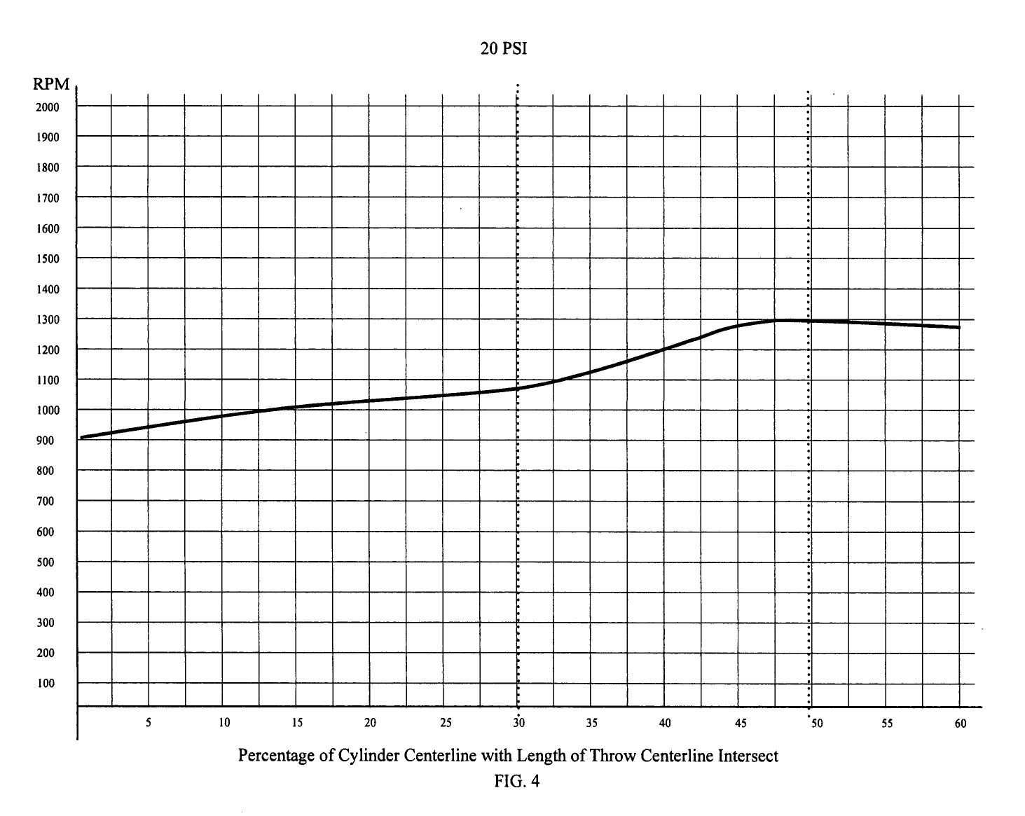

### FIGS. 3 and 4—First Embodiment

The unique technique I used to measure the torque and performance gains offered by the angled-cylinder piston device employed the use of a hobby-grade steam engine. The reasons for choosing this device were as follows:

1. Steam engines are typically built with open architecture lower ends. The crankshaft and connecting rod assemblies are not enclosed within a crankcase, and therefore they are exposed for easy experimentation.

2. The cylinder and piston assemblies of the steam engine used are constructed as individual components, and then mounted to a plate. The plate is then mounted to the lower assembly by means of machined posts. Adding a system of shims to these posts was a simple procedure, thus creating an assembly that could easily produce variable cylinder angles.

3. Steam engines are external combustion engines, and lend themselves to simple modifications that allow them to operate on controlled compressed air. This was critical, as my intention was to identify the performance gains offered by the angled-cylinder technique, without considerations of heat dissipation and accumulation, combustion gas expansion variations due to a multitude of factors, friction increases and decreases, and other variables related to combustion engines that could distort my observations. The modified steam engine allowed me to run tests that isolated the performance and torque gains inherent in the mechanical advantage of the angled-cylinder technique.

The test engine was assembled with the above mentioned modifications. The output shaft was fitted with a cogged-belt pulley that allowed coupling to an electric generator, also fitted with a cogged pulley, and joined with a cogged belt. The engine's pulley was also marked to allow engine revolutions-per-minute (RPM) readings to be made with an optical tachometer. Extensive tests were conducted, and the results were consistent. FIG. 3 is a chart of typical test results produced when voltage readings were taken at various cylinder angles. FIG. 4 is a chart of typical test results produced when RPM readings were taken at various cylinder angles.

Referring to this modification as cylinder angle became futile, as the small adjustments necessary became too difficult to gauge accurately when measured as cylinder angle. Therefore, I developed the more precise technique of measuring this configuration in terms of the cylinder's centerline with length of throw's centerline intersect. A traditional piston device would have its cylinder oriented in a manner such that its centerline would be drawn directly through the piston pivot center axis 25, and the crankshaft main axis 34. Using the throw 31 positioned at 90° of a clockwise crankshaft rotation 31, and measuring from the crankshaft main center axis 34 to the crankpin center axis 32, a cylinder oriented in such a manner as to have its centerline 37 intersect with throw's centerline 36 can have its orientation calibrated in terms of a percentage of the length of throw centerline 36, 38. Going forward, this measurement will be referred to as throw centerline intersect 45. This method of determining cylinder orientation can be effectively used when designing either an angled-cylinder, or an offset-crankshaft piston device.

What these tests allowed me to conclude are as follows:

1. The configuration of the cylinder's centerline 37 with the length of throw centerline 36, 38 is extremely critical. Very minute changes to the cylinder angle produces measurable changes in torque and performance.

2. The performance and torque gains that can be gleaned from the angled cylinder technique are not linear. During testing, as the cylinder's centerlines 37 were oriented away from the crankshaft main axis 34 and towards the crankpin center axis position held at 90° of a clockwise rotation 32, the gains were rather small until I approached a throw centerline intersect 45 of 30%. The gains then increased exponentially until reaching a throw centerline intersect 45 of 45%, and then began to decrease. Gains in performance rapidly decreased after reaching a throw centerline intersect 45 of 49% . It is within the range of a throw centerline intersect 45 of 30% to 49% that performance increases of 15% or more can be realized, and this range of cylinder 22 orientation is within the scope of the present embodiment.

### FIGS. 1, 2 and 5—Second Embodiment

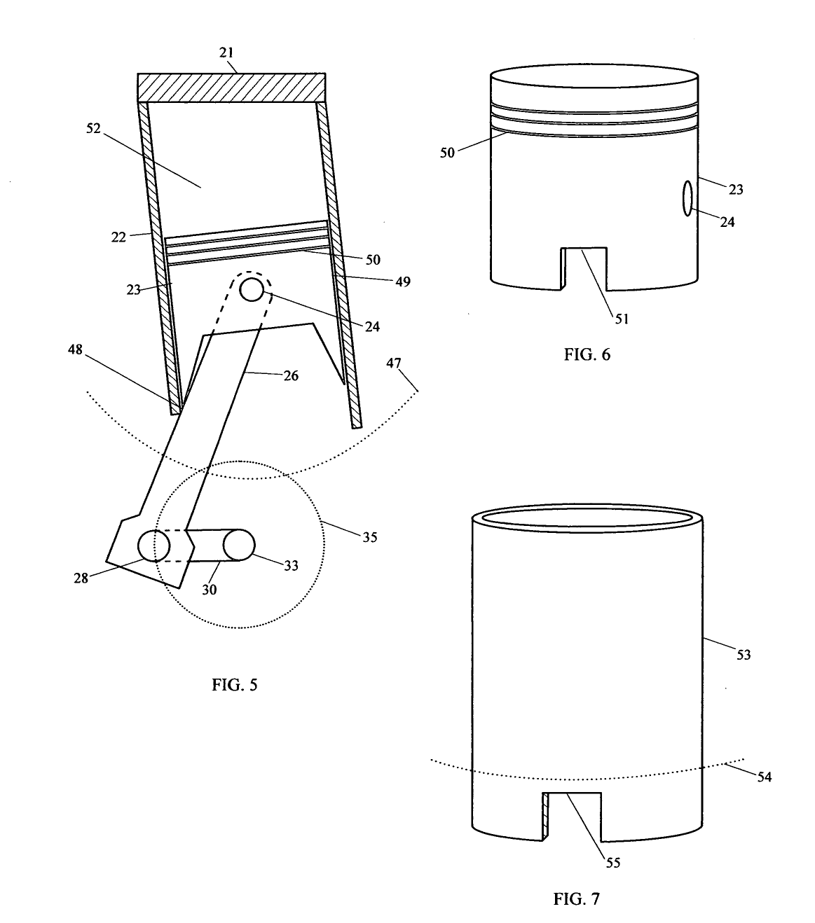

Piston devices designed to operate with a throw centerline intersect of 30% to 49% present certain challenges. FIG. 5, reference 48, illustrates a limitation that would be presented when applying this technique to traditional or existing designs. The increased swing of the connecting rod 47 opposite the direction of cylinder angle or cylinder offset can cause an interference between the connecting rod 26 and the bottom of the piston 23. This interference can also occur with the connecting rod 26, and the bottom of the cylinder 22. A solution to this problem provided by this embodiment, is to balance the amount of throw centerline intersect 45 with the degree of interference, which is in direct proportion to the devices connecting rod-to-stroke ratio. A piston device with a ratio of 1.5/1 respectively or less presents the greater amount of interference and therefore permits lower amount of throw centerline intersect 45, and therefore a throw centerline intersect 45 of 33%, +/−3% of length of throw is determined. A piston device with a ratio of 1.9/1 respectively or greater presents the least amount of interference and therefore permits a greater amount of throw centerline intersect 45, and a value of 46%, +/−3% of length of throw is determined. Piston devices with connecting rod-to-stroke ratios between 1.5/1 to 1.9/1 would have the throw centerline intersect 45 determined proportionally with respect to the above described limits, +/−3% of length of throw. The 3% tolerance is to allow for other device characteristics such as connecting rod 26 width, or piston 23 diameter. This method of determining cylinder centerline 37 orientation is within the scope of the present embodiment.

### FIGS. 5 and 6—Third Embodiment

Another concern when designing an angled-cylinder piston device is the interference between the connecting rod 26 and the piston's 23 base as shown in FIG. 5, reference 48. A solution to this issue provided by this embodiment is the recessed piston 46 as shown in FIG. 6. A cut out 51 formed at the base of the piston 46, or in the piston skirt if so designed, and oriented in a manner to accommodate the swing of the connecting rod 26, will provide clearance for the free operation of the connecting rod 26 throughout the crankshaft's 28,30,33 360° rotation cycle. This piston design is within the scope of the present embodiment.

### FIGS. 5 and 7—Fourth Embodiment

Another concern when designing an angled-cylinder piston device is the interference between the connecting rod 26 and the cylinder's 22 base, as shown in FIG. 5, reference 48. A solution to this issue provided by this embodiment is the recessed cylinder sleeve 53 as shown in FIG. 7. A sleeve inserted into a cylinder's bore 52, and having a cut out 55 that is oriented in a manner to accommodate the swing of the connecting rod 26, will provide clearance for the free operation of the connecting rod 26 throughout the crankshaft's 360° rotation cycle. This sleeve design is very effective, as piston devices designed using the angled-cylinder technique would require extremely accurate relationships between the piston rings 50, and the cut out 55 in the sleeve. Therefore, providing such a cut out formed in a bored block would be challenging in the manufacturing process. A sleeve designed as described could be held in the bore 52 either mechanically or through some bonding means, but would require some mechanical means to keep it from rotating within the cylinder bore 52. A misalignment between the connecting rod 26 and the cut out 51 would lead to failure. This sleeve design is within the scope of the present embodiment.

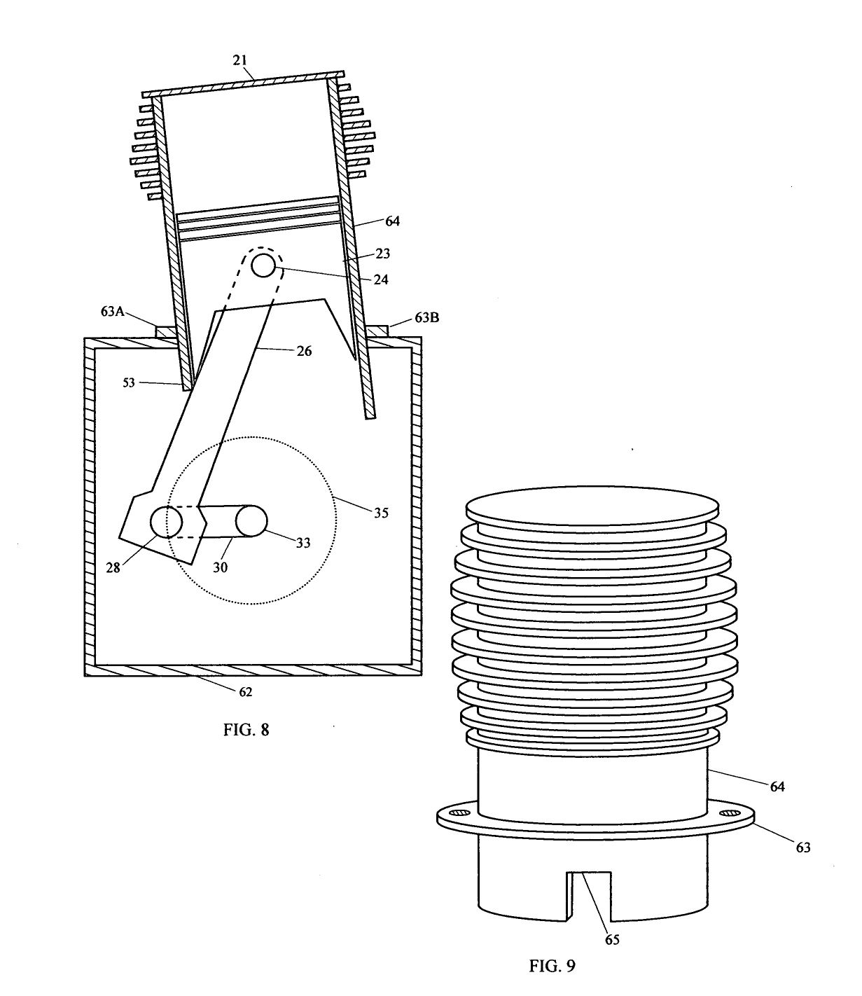

### FIGS. 8 and 9—Fifth Embodiment

When designing an angled-cylinder piston device that is constructed as a separate cylinder 64 and crankcase 62 as shown in FIG. 9, the area of connection rod to cylinder interference is indicated at reference 53. A relief cut out formed at the base of the cylinder 64, and oriented in a manner such as to accommodate the swing of the connecting rod 26, would allow for the free operation of the connecting rod 26 throughout the crankshafts 360° rotation cycle. This cylinder design is within the scope of the present embodiment.

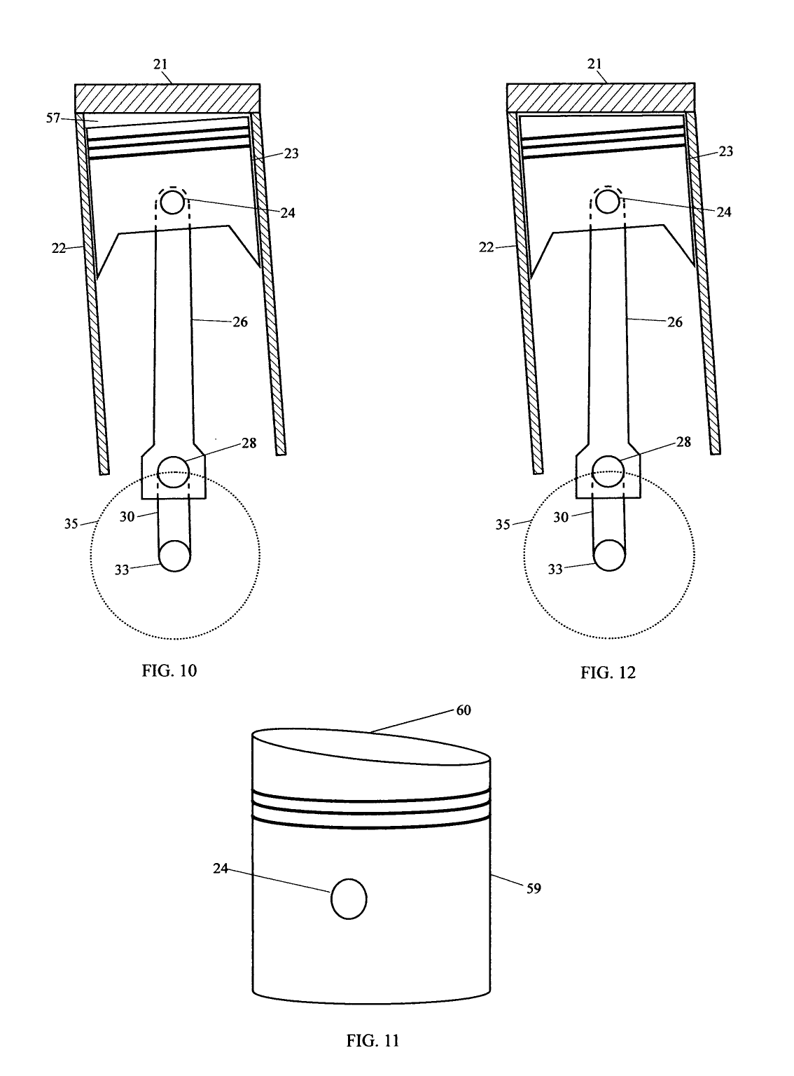

### FIGS. 10, 11 and 12—Sixth Embodiment

A designer of an angled-cylinder piston device wishing to avoid re-designing as many peripheral components as possible may take the approach of angling the cylinder 23 about the piston pivot 24 location at TDC in the original design. This design technique would avoid having to re-design the cylinder heads 21, but would create a condition of excess cylinder volume 57 when the piston is positioned at TDC, as shown in FIG. 10. A solution to this problem is to design a piston 59 whose top is formed in such a manner as to compensate for this excess volume, as shown in FIG. 12. This solution may prevent the re-designing of many other internal and external components as well. This piston design is within the scope of the present embodiment.

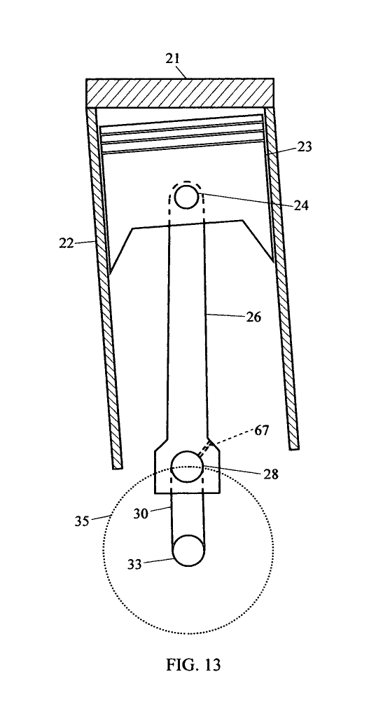

### FIGS. 5 and 13—Seventh Embodiment

Another concern when designing an angled-cylinder piston engine is the increase in friction between the piston 23 and the cylinder 22 wall as shown in FIG. 5, reference 49. This increase in friction occurs as the piston travels from BDC to TDC. If the piston engine is centrally lubricated, an oil passage 67 formed in the connecting rod 26, and oriented in such a manner as to apply additional oil to the affected area of the cylinder's 22 wall as shown in FIG. 13, would solve this issue. The movement of the connecting rod 26 as the crankpin 28 travels from BDC to TDC would provide excellent oil distribution. An oil passage properly formed in the crankshaft 28,30,33 would provide the same benefit. This method of design is within the scope of the present embodiment

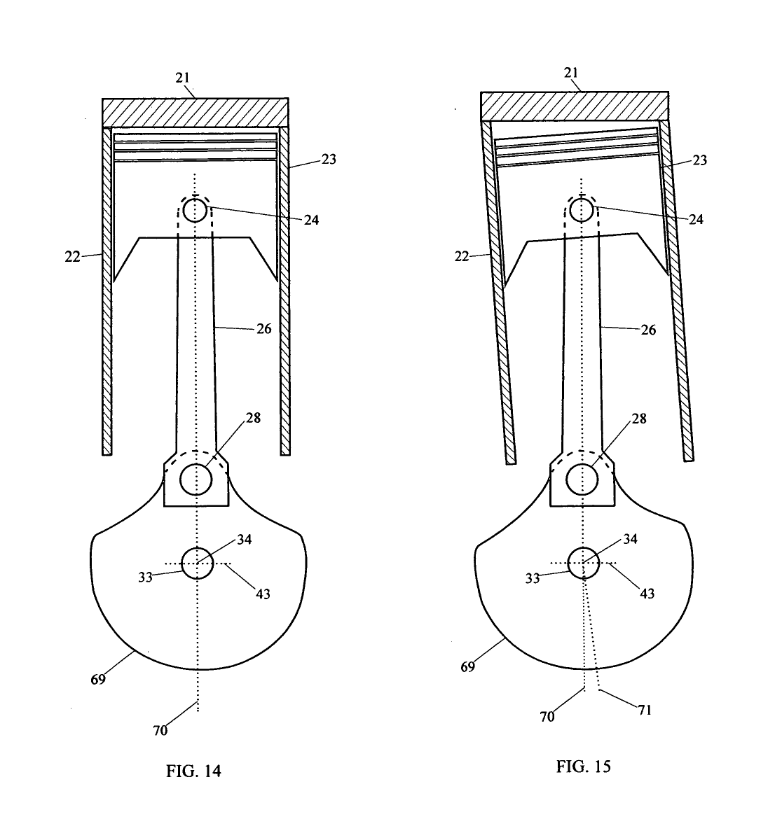

### FIGS. 14 and 15—Eighth Embodiment

Another concern when designing an angled-cylinder piston device is an imbalance of the crankshaft 28,30,33 created by directing the weight of the piston 23 and connecting rod 26 assembly away from BDC. FIG. 14 shows prior art that illustrates the configuration of a traditional piston device with a crankshaft counterweight 69 oriented exactly opposite the piston pivot 24 when the crankshaft 28,30,33 is positioned at TDC. An imaginary centerline 70 can be drawn through the piston pivot 24, the crankshaft main axis 33, and the center of the counterweight 69. FIG. 15 shows a method of design that corrects this imbalance. By retarding the orientation of the counterweights center 71 away from the crankshaft's 28,30,33 operational rotation, the crankshaft's 28,30,22 balance of the angled-cylinder piston device can be corrected. This method of design is within the scope of this embodiment.

Thus the scope of the embodiments should be determined by the appended claims, and their legal equivalents, rather than by the examples given.

### DRAWINGS

### Figures

FIG. 1 shows a cross section of a cylinder, piston and crankshaft assembly which is an example of an angled-cylinder configuration with the crankshaft positioned at top dead center. Also, an alternate position of the crankpin with the crankshaft positioned at 90° past top dead center of a clockwise rotation is shown.

FIG. 2 shows a cross section of a cylinder, piston and crankshaft assembly which is an example of an offset crankshaft, or offset cylinder configuration with the crankshaft positioned at top dead center. Also, an alternate position of the crankpin with the crankshaft positioned at 90° past top dead center of a clockwise rotation is shown.

FIG. 3 shows test results expressed as voltage readings.

FIG. 4 shows test results expressed as revolutions per minute.

FIG. 5 shows an angled cylinder piston device with the crankpin located at 270° past top dead center of a clockwise crankshaft rotation. This figure shows the interference between the connecting rod with the bottom of the cylinder and/or piston bottom.

FIG. 6 shows an example of a recessed piston with a relief cut out.

FIG. 7 shows an example of a recessed cylinder insert sleeve with a relief cut out.

FIG. 8 shows an example of an angled cylinder piston device constructed as a separate cylinder affixed to a crankcase.

FIG. 9 shows an example of a separately constructed cylinder with a relief cut out.

FIG. 10 shows an angled-cylinder piston device with the crankshaft positioned at top dead center. This figure shows the excess volume of the cylinder chamber at top dead center.

FIG. 11 shows an example of a compensating piston.

FIG. 12 shows an angled cylinder piston device with the crankshaft positioned at top dead center. This figure shows the excess volume of the cylinder chamber at top dead center corrected with a compensating piston.

FIG. 13 shows an example of an angled cylinder piston device with an additional lubrication passage.

FIG. 14 shows an example of prior art of a piston device with the crankshaft positioned at top dead center, and the crankshaft counterweight in a traditional configuration.

FIG. 15 shows an example of an angled cylinder piston device with the crankshaft positioned at top dead center, and with the crankshaft counterweight centerline adjusted to re-balance the crankshaft, connecting rod, and piston assembly.

### DRAWINGS

### Reference Numerals

21 cylinder head
22 cylinder
23 piston
24 piston pivot
25 piston pivot center axis
26 connecting rod
27 length of connecting rod
28 crankpin
37 centerline of cylinder
29 crankpin center axis
38 length of throw
30 throw
31 crankpin position at 90° past top dead center of a clockwise crankshaft rotation
32 crankpin center axis position at 90° past top dead center of a clockwise crankshaft rotation
33 crankshaft main journal
34 crankshaft main axis
35 stroke path of crankpin center axis
36 throw centerline location at 90° past top dead center of a clockwise crankshaft rotation
37 centerline of cylinder
38 length of throw
39 throw position at 90° past top dead center of a clockwise crankshaft rotation
40 piston pivot horizontal centerline
41 connecting rod centerline
42 stroke diameter
43 crankpin horizontal centerline
44 crankshaft main axis vertical centerline
45 cylinder centerline with length of throw centerline intersect
46 recessed piston
47 connecting rod swing
48 point of interference
49 point of increased friction
50 piston rings
51 piston bottom cut out
52 cylinder bore
53 recessed cylinder sleeve
54 location of cylinder bore bottom
55 cylinder sleeve cut out
57 area of excess cylinder volume
59 compensating piston
60 compensating piston top
62 crankcase
63 cylinder mounting flange
64 separately constructed cylinder
65 separately constructed cylinder cut out
67 oil passage
69 crankshaft counterweight
70 crankshaft counterweight centerline
71 crankshaft counterweight centerline adjusted orientation

1. A method for determining the optimum orientation for cylinder or cylinders of an angled cylinder piston engine comprising;
a. at least one crankshaft, comprising at least one throw with crankpin, journaled for rotation about a main axis of said engine and
b. at least one cylinder within a respective piston reciprocates along a respective piston cylinder axis as said piston executes a repeating operating cycle that comprises an expansion stroke during which pressure is applied to said piston and
c. at least one connecting rod each of which is pivotally connected to a said respective piston with a said respective throw to relate reciprocal motion of said piston and the rotation of said crankshaft and
d. having a length of said throw measured from the center of said main axis of said crankshaft to the center of said crankpin and
e. having a connecting rod length measured from the center of said piston pivot to center of said crankpin and
f. said crankshaft having a stroke diameter measured from said crankpin center position with said crankshaft positioned at top dead center to the said crankpin center position with crankshaft positioned at bottom dead center and
g. having a connecting rod to stroke ratio determined by dividing said length of connecting rod by said diameter of said stroke and
h. at least one cylinder being oriented about said piston pivot with said crankshaft positioned at top dead center in such a manner as to create an instance such that when said throw of said crankshaft is positioned at 90° in the direction of operating travel past top dead center, concurrently, the imaginary centerline of said cylinder intersects with the imaginary centerline of said throw between the amounts of 30% of said length of throw and 49% of said length of throw, measured from the center of said main axis of said crankshaft to the center of said crankpin.

2. A piston engine designed using the method described in claim 1.

3. (canceled)

4. (canceled)

5. A method for determining the optimum orientation for cylinder or cylinders of an angled cylinder piston pump or compressor comprising;
a. at least one crankshaft, comprising at least one throw with crankpin, journaled for rotation about a main axis of said pump or compressor and
b. at least one cylinder within a respective piston reciprocates along a respective piston cylinder axis as said piston executes a repeating operating cycle that comprises a compression stroke during which pressure is applied to said piston and
c. at least one connecting rod each of which is pivotally connected to a said respective piston with a said respective throw to relate reciprocal motion of said piston and the rotation of said crankshaft and
d. having a length of said throw measured from the center of said main axis of said crankshaft to the center of said crankpin and
e. having a connecting rod length measured from the center of said piston pivot to center of said crankpin and
f. said crankshaft having a stroke diameter measured from said crankpin center position with said crankshaft positioned at top dead center to the said crankpin center position with crankshaft positioned at bottom dead center and
g. having a connecting rod to stroke ratio determined by dividing said length of connecting rod by said diameter of said stroke and
h. at least one cylinder being oriented about said piston pivot with said crankshaft positioned at top dead center in such a manner as to create an instance such that when said throw of said crankshaft is positioned at 270° in the direction of operating travel past top dead center, concurrently, the imaginary centerline of said cylinder intersects with the imaginary centerline of said throw between the amounts of 30% of said length of throw and 49% of said length of throw, measured from the center of said main axis of said crankshaft to the center of said crankpin.

6. A piston pump or compressor designed using the method described in claim 5.

7. (canceled)

8. (canceled)

9. An angled cylinder piston device with recessed cylinder sleeve comprising;
a. at least one crankshaft, comprising at least one throw with crankpin, journaled for rotation about a main axis of the piston device and
b. at least one cylinder within a respective piston reciprocates along a respective piston cylinder axis as said piston executes a repeating operating cycle and
c. at least one connecting rod each of which pivotally connects a said respective piston with a said respective throw to relate reciprocal motion of said piston and the rotation of said crankshaft and
d. at least one of said cylinders being oriented in a manner such that said imaginary centerline of said cylinder is not parallel to said imaginary centerline of said connecting rod when said crankshaft is positioned at top dead center and
e. at least one said cylinder containing a sleeve affixed to a bore of said cylinder, either mechanically or a bonding means, having an area of cut out formed in the base of said sleeve, and oriented in a manner such as to provide clearance to accommodate the swing of said connecting rod throughout the 360° rotation sequence of said crankshaft.

10. An angled cylinder piston device with compensating piston comprising;
a. at least one crankshaft, comprising at least one throw with crankpin, journaled for rotation about a main axis of the piston device and
b. at least one cylinder within a respective piston reciprocates along a respective piston cylinder axis as said piston executes a repeating operating cycle and
c. at least one connecting rod each of which pivotally connects a said respective piston with a said respective throw to relate reciprocal motion of said piston and the rotation of said crankshaft and
d. at least one of said cylinders being oriented in a manner such that said imaginary centerline of said cylinder is not parallel to said imaginary centerline of said connecting rod when said crankshaft is positioned at top dead center and
e. at least one of said cylinders containing a said piston having a top whose plane is not perpendicular to said imaginary centerline of said cylinder.

11. An angled cylinder piston device with recessed piston comprising;
a. at least one crankshaft, comprising at least one throw with crankpin, journaled for rotation about a main axis of the piston device and
b. at least one cylinder within a respective piston reciprocates along a respective piston cylinder axis as said piston executes a repeating operating cycle and
c. at least one connecting rod each of which pivotally connects a said respective piston with a said respective throw to relate reciprocal motion of said piston and the rotation of said crankshaft and
d. at least one of said cylinders being oriented in a manner such that said imaginary centerline of said cylinder is not parallel to said imaginary centerline of said connecting rod when said crankshaft is positioned at top dead center and
e. at least one of said cylinder containing a said piston having an area of cut out formed in the base of said piston, and oriented in such a manner as to provide clearance to accommodate the swing of said connecting rod throughout the 360° rotation sequence of said crankshaft.

12. An angled cylinder piston device comprising;
a. at least one crankshaft, comprising at least one throw with crankpin, journaled for rotation about a main axis of the piston device and
b. at least one cylinder within a respective piston reciprocates along a respective piston cylinder axis as said piston executes a repeating operating cycle and
c. at least one connecting rod each of which pivotally connects a said respective piston with a said respective throw to relate reciprocal motion of said piston and the rotation of said crankshaft and
d. at least one of said cylinders being oriented in a manner such that said imaginary centerline of said cylinder is not parallel to said imaginary centerline of said connecting rod when said crankshaft is positioned at top dead center and
e. a central lubrication system and
f. a lubrication passage formed in said crankshaft or an assembly of said connecting rod and oriented in a manner such as to provide additional lubrication to said cylinder adjacent to the direction of said cylinder angle.

13. (canceled)

14. (canceled)

15. An angled cylinder piston device as described in claim 9 and at least one of said cylinder being constructed separately from, and affixed to a crankcase, and having an area of cut out formed in the base of said cylinder, and oriented in a manner such as to provide clearance to accommodate the swing of said connecting rod throughout the 360° rotation sequence of said crankshaft.
